(19) United States
(12) Patent Application Publication
(10) Pub. No.: US 2014/0242197 A1
(43) Pub. Date: Aug. 28, 2014

(54) COMPOSITIONS AND METHODS FOR THE TREATMENT OF DISEASES ON PLANTS

(71) Applicant: ORO AGRI INC., Trophy Club, TX (US)

(72) Inventors: Melvin Donovan PULLEN, Burbank, CA (US); Dirk Cornelius UYS, Somerset West (ZA)

(73) Assignee: ORO AGRI INC., Trophy Club, TX (US)

(21) Appl. No.: 13/802,559

(22) Filed: Mar. 13, 2013

(30) Foreign Application Priority Data
Feb. 28, 2013 (MY) PI2013000705

(51) Int. Cl. A01N 65/36

(52) U.S. Cl. CPC A01N 65/36
USPC 424/736

(57) ABSTRACT

The present invention provides a method of treating root rot fungus, particularly Armillaria, in plants comprising applying an effective amount of a composition comprising one or more surfactants, one or more alcohols, and one or more high terpene containing oil.

### RELATED APPLICATION

This application claims the benefit of Malaysian Application PI2013000705 filed on Feb. 28, 2013, which is hereby incorporated by reference in its entirety. The present invention relates to the similar growth habit fungi as Ganoderma and priority is claimed to the method of treatment disclosed in the Malaysian application.

### FIELD OF THE INVENTION

This invention relates to a method of treating root rot.

### BACKGROUND TO THE INVENTION

Root rot is a condition found in both indoor and outdoor plants, although more common in indoor plants with poor drainage. As the name states, the roots of the plant rot. Usually, this is a result of overwatering. In houseplants, it is a very common problem, and is slightly less common in outdoor plants. In both indoor and outdoor plants, it is usually lethal and there is no effective treatment.

The excess water makes it very difficult for the roots to get the air that they need, causing them to decay. To avoid root rot, it is best to only water plants when the soil becomes dry, and to put the plant in a well-drained pot. Using a heavy soil, such as one dug up from outdoors can also cause root rot.

Many cases of root rot are caused by members of the water mould genus Phytophthora. Perhaps the most aggressive is P. cinnamomi. Spores from root rot causing agents do contaminate other plants, but the rot cannot take hold unless there is adequate moisture. Spores are not only airborne, but are also carried by insects and other arthropods in the soil.

A specific root rot disease is Armillaria. This disease is found throughout temperate and tropical regions of the world. Hosts include hundreds of species of trees, shrubs and agricultural crops such as grapevines kiwi fruit, fruit trees, coffee, tea, cocoa, blackberry, flowering bulbs, cassava potato, raspberry, strawberry and ornamentals.

Armillaria root rot or shoestring root rot is caused by Armillaria mellea, a common and damaging soil borne fungus. Armillaria is used loosely to refer to a group of about 20 genetically distinct fungal species that can be distinguished most readily using serological techniques. Common names for this group include oak fungus, shoestring root rot, honey mushroom, and honey agaric. The latter two refer to the color of the mushroom fruiting structure of the fungus that can sometimes be seen at the base of infected trees.

Armillaria causes mortality, wood decay, die-back, collar rot, premature defoliation, stunted shoots and overall growth reduction. It infects and kills plants that have been already weakened by competition, other pests, or climatic factors. It also infects healthy plants, either killing them outright or predisposing them to attacks by other fungi or insects.

The main method of spreading of the fungus is by way of contact between infected and non-infected roots. Infection from one plant may spread to plants in its surroundings with the infected areas expanding progressively.

As these fungi are indigenous to many areas and live on a wide variety of plants and woody material, their eradication or complete exclusion is not feasible and the available control measures are directed toward limiting disease build-up or reducing its impact. Biological control methods such as by Trichoderma are available, but are expensive and limited in effect. A plant with root rot will normally not survive, but can often be propagated so it will not be lost completely. Plants with root rot should be removed and destroyed.

### SUMMARY OF THE INVENTION

The applicant has surprisingly found that the composition of the current invention provides a method for improving drainage with a resultant better supply of oxygen in the soil for the roots, thereby creating soil conditions that eliminates or at least control root rot.

The composition and method particularly provide a method for treatment of the Armillaria disease.

The invention is directed to a method for treating root rot and in particular the Armillaria disease in plants by means of an effective composition increasing the lateral movement of water in a treated soil and thereby improving drainage of the soil compared to the lateral movement of water in soil that has not been subjected to treatment. This ensures a better supply of oxygen in the soil and to the roots of the disease infected plant, enhancing its growth and controlling root rot. In certain embodiments, the method comprises selecting soil wherein the affected plants are growing and applying an effective amount to the soil of the composition comprising one or more surfactants, one or more alcohols and one or more high terpene based oils to the soil and thereby increasing the drainage of the soil and effectively controlling root rot.

The invention is also directed at the destruction of root rot and in particular embodiments the invention is directed at the destruction of the Armillaria organism. The orange oil and the hydrophobic parts of the surfactants in the product of the invention are attracted to the hydrophobic organic material and fungal hyphae in the soil. Orange oil is a fat solvent and as such will dissolve phospholipids in the cell membranes of the fungal hyphae, destroying them.

In certain embodiments, the invention is directed to methods comprising the steps of providing a concentrate comprising one or more surfactants, one or more alcohols and one or more high terpene containing oils; applying said diluted concentrate on the base of the plant and the soil surrounding the plant via spraying, drenching dribbling, watering or any other method of application. In certain embodiments, the concentrate is applied at a rate of about 1 litre/hectare to 100 litres/hectare. In certain embodiments, the compositions of the invention are applied at a rate of about 2 litres/hectare to 50 litres/hectare. In certain embodiments, the compositions of the invention are applied at a rate of about 5 litres/hectare to 30 litres/hectare. In certain embodiments, the compositions of the invention are applied at a rate of about 8 litres/hectare to 20 litres/hectare. In certain embodiments, the compositions of the invention are applied at a rate of about 10 litres/hectare to 15 litres/hectare. In certain preferred embodiments, compositions of the invention are concentrates. In certain embodiments, the concentrate is diluted at a dilution rate of 0.01% to 2% and the dilution is applied at a rate of between 100 to 100 000 litres/hectare.

In certain embodiments, the invention is directed to compositions comprising one or more surfactants, one or more alcohols and one or more high terpene containing oils. In certain embodiments, the one or more high terpene containing oil is a citrus oil. In certain embodiments, the high terpene containing oil is selected from the group consisting of orange oil, lemon oil, lime oil, grapefruit oil and tangerine oil.

In a preferred embodiment, the high terpene containing oil is orange oil. In certain embodiments, the composition is a concentrate comprising from about 1% by weight to about 35% by weight orange oil. In certain embodiments, the concentrate comprises from about 2% to about 15% by weight orange oil. In certain embodiments, the concentrate comprises about 5% to about 12% orange oil. In certain preferred embodiments, the concentrate comprises about 10% orange oil. In certain preferred embodiments, the orange oil is Valencia orange oil. In still further preferred embodiments, the orange oil is cold pressed orange oil.

In certain embodiments, the composition further comprises an alcohol.

In certain embodiments, the composition further comprises ethyl alcohol. In certain embodiments, the composition is a concentrate comprising from about 1% by weight to about 15% by weight ethyl alcohol. In certain embodiments, the concentrate comprises from about 2% to about 10% by weight ethyl alcohol. In certain embodiments, the concentrate comprises about 3% to about 7% ethyl alcohol. In certain preferred embodiments, the concentrate comprises about 5.5% ethyl alcohol.

In certain embodiments, the composition further comprises secondary alcohol ethoxylate. In certain embodiments, the composition is a concentrate comprising from about 10% by weight to about 30% by weight secondary alcohol ethoxylate. In certain embodiments, the concentrate comprises from about 15% to about 25% by weight secondary alcohol ethoxylate. In certain embodiments, the concentrate comprises about 18% to about 22% secondary alcohol ethoxylate. In certain preferred embodiments, the concentrate comprises about 20% secondary alcohol ethoxylate.

In certain embodiments the alcohol is propylene glycol. In certain embodiments, the composition is a concentrate comprising from about 5% by weight to about 20% by weight propylene glycol. In certain embodiments, the concentrate comprises from about 6% to about 9% by weight propylene glycol. In certain embodiments, the concentrate comprises about 8% to about 9% propylene glycol. In certain preferred embodiments, the concentrate comprises about 8.8% propylene glycol.

### BRIEF DESCRIPTION OF THE DRAWINGS

FIG. 1 illustrates shoot growth rating on grapevines for four applications at 10 litres/hectare during the growth season. The more the grapevines were affected by Armillaria root rot during the past, the less pruning wood was left in the year prior the experiment. The product of the invention resulted in the most improved shoot growth in the weakest vines.

### DETAILED DESCRIPTION

Armillaria disease may occur in many soil conditions however soils with poor drainage and soils in higher rainfall areas pose more problems. Poor drainage leads to a lack of sufficient oxygen in the soil. Roots need oxygen to grow and function. Roots systems thus impaired subsequently become targets for attack by fungi such as Armillaria and Ganoderma.

This disease has brought about considerable economic loss to horticultural, forestry and amenity plantings. To date, control options are limited, with removal of the infected material as the only proven successful management procedure. (Smith-White, J. L., Summerell, B. A., 2003. Armillaria root rot. Microbiology Australia. 24, 31-32)).

It is known in the prior art that Armillaria is a fatal and problematic disease See enman, S., Coetzee, M. P. A., Wingfield, B. D., Wingfield, M. J., Crous, P. W., 2000, July. Armillaria Root Rot: A new disease of cut-flower proteas in South Africa. SAPPEX News. Issue 106; Gubler, W. D., Baumgartner, K., Browne, G. T., Eskalen, a., Latham, S. R., Petit, E., Bayramian, L. a., 2004. Root diseases of grapevines in California and their control. Australasian Plant Pathology. 33, 157; Guillaumin, J. J., Bérubé, J., Botton, B., Cha, J. Y., Desray, P., Dubos, B., Guyon, D., Laflamme, G., Legrand, P., Lung-Escarmant, B., 2005. L'armillaire et le pourridié-agaric des végétaux ligneux. Guillaumin, J. J., Legrand, P., Lung-Escarmant, B., Botton, B. (Eds.). Institut National de la Recherche Agronomique, Montpellier, France, p. 487; Homer, I. J., 1991. Epidemiology of Armillaria root rot on Kiwi-fruit. Acta Horticulturae. 297, 573-578; Sekamatte, M. B., Okwakol, M. J. N., 2007. Review article The present knowledge on soil pests and pathogens in Uganda. African Journal of Ecology. 45, 9-19

As a consequence of the method of treatment using the compositions better drainage in the root zone prevents Armillaria from infecting the target plant and stops further progress of the disease. Improving drainage and lateral movement of water in the soil with a resultant better supply of oxygen in the soil for roots, root systems can be induced to develop more prolifically. Roots need oxygen to grow, function properly and absorb nutrients to supply the foliage. Oxygen in the soil also stimulates the activity of “good” aerobic soil organisms that suppress plant pathogenic organisms, for example, by competing for the same food source that is used by the pathogenic organisms. Armillaria breaks down un-decomposed organic material to extract nourishment from it. Once it gets a foothold and increases in numbers, it can invade the live tissues of the crop plant, either killing them outright or predisposing them to attacks by other fungi or insects.

Organic material in soil is hydrophobic, that is, it tends to repel water. This also holds true for either dead or live plant roots. In order for a soil borne fungus to be able to attach to such plant material, it must also develop a hydrophobic surface which will in turn repel hydrophilic substances such as water and anything dissolved in water. The orange oil in the product of the invention is hydrophobic and it will be attracted to hydrophobic surfaces such a mentioned plant material as well as the fungus. The same will happen to the hydrophobic parts of the surfactant molecules in the product of the invention.

The orange oil in the product of the invention is encapsulated in nanometer sized micelles which are formed by the orange oil, surfactants and alcohols. The outer surface of the micelles is hydrophilic so that it will move with soil water until a hydrophobic surface is reached, to which it will attach. The orange oil is the most hydrophobic part of the micelle and as such it will then be attracted to the organic plant material and the hydrophobic fungal hyphae. Orange oil is a fat solvent and as such will dissolve phospholipids in the cell membranes of the fungal hyphae, destroying them.

Control of Armillaria is therefore obtained by direct killing of the fungus as well as the indirect way of improving soil conditions by drainage to create less favourable conditions for the Armillaria and more favourable conditions for soil organisms that can aid in its suppression.

As used herein, high terpene containing natural oil means those natural oils having a terpene content of at least 50%. It is preferable that the high terpene natural oil contains at least 65% terpene. Suitable high terpene containing natural oils includes oil such as citrus peel oils, preferably orange oil, grapefruit oil, lemon oil, lime oil, pine oil or tangerine oil. Of these, orange oil is preferred and cold pressed orange oil the most preferred. The preferred terpene content is from about 80% to about 95% and further preferred from about 85 percent to about 87%, and most preferred from about 90 to about 97%, all by weight. D′Limonene (Terpene of Citrus or other natural oils) may also be used.

As used herein, the terms “terpene” or “high terpene” refer to any of a class of chemical compounds that are widespread in nature, mainly in plants as constituents of essential oils. Many terpenes are hydrocarbons, but oxygen-containing compounds such as alcohols, aldehydes or ketones (terpenoids) are also found.

The one or more high terpene (50% by weight or more) based oils, such as, but not limited to, citrus oil compositions of the present invention is in the form of a liquid.

Preferably, the one or more high terpene (50% terpene by weight or more) based oils such as but not limited to citrus oil compositions of the invention may comprise from about 0.5% to about 35%, or preferably about 1% to about 30% one or more high terpene (50% terpene by weight or more) based oils such as but not limited to citrus oil by weight. In certain preferred embodiments, the one or more high terpene (50% terpene by weight or more) based oils such as but not limited to citrus oil compositions of the invention may comprise about 12% to about 20% or about 12% to about 18% or about 10% citrus oil by weight, relative to the total weight of the composition.

Preferably, the composition of the invention may comprise about 1 to about 15% by weight of alcohol, relative to the total weight of the composition.

Preferably, the composition of the invention may comprise about 3% to about 90% by weight surfactant or any percent by weight within this range. Preferably, about 5% to about 20% by weight of surfactant, relative to the total weight of the composition.

As used herein the term “about” means approximately or in the region of, such that the values encompassed by the number are related to the significant digits in the number.

As used herein the terms “from” and “between” in the description of values or ranges include the upper and lower limits.

The following examples illustrate exemplary methods provided herein. These examples are not intended, nor are they to be construed, as limiting the scope of the disclosure. It will be clear that the methods can be practiced otherwise than as particularly described herein. Numerous modifications and variations are possible in view of the teachings herein and, therefore, are within the scope of the disclosure.

### EXAMPLE

### Example 1

### Effect of Product of the Invention Applied to Pinot Noir Impacted by Armillaria Root Rot

The method of treatment is illustrated by applying the product to a severely affected wine grape vineyard resulting in a turn-around in the growth of the previously declining vines.

Materials and Methods:

An existing Merlot vineyard that was re-budded to Pinot Noir 2007 was used for the trial plot. Armillaria root rot had attacked many of the vines. The Armillaria starts to cover the roots and over time the vines become weaker and weaker and eventually die. Of the 2.5 acres there were over 200 dead vines and another 100 that were very weak. As the Armillaria takes over more of the root system, the vines grow slower and shut down earlier in the season. Leaves will thus turn red also early in the season.

The method of treatment included dripping the product onto the ground around the affected vines through an irrigation system at 10 litres per hectare during spring and early summer of 2010. Four applications were applied over about 1 month intervals. An untreated section of the vineyard was kept as a Control, designated UTC. Each vine was cane pruned according to its strength at the end of 2009 season. Thus each vine could be compared for growth relative to the number of canes.

A vine pruned to a spur only in 2009 was an older vine that was declining. The canopy in 2009 was too weak to justify leaving a full cane. This canopy in 2009 would have had a rating less than 2. Evaluating the growth in the current year provides a relative strength.

Likewise vines with one cane trained from 2009 would have only had one cane from the prior year strong enough in length and circumference to justify laying down a cane. Two canes are laid down for a normal vine and three canes are laid down for very strong vines.

In October 2010 the vines were evaluated for growth according to a rating scale based on the new shoot growth. A rating of 1 was given for weak new shoot growth, 2 for shoot growth that had reached the top wire of the trellis but where the growth of the tip had stopped. On the other end of the scale a rating of 5 was given for vigorous new shoot growth that had reached the top wire of the trellis and where the shoot tips were still growing actively. A total of 44 vines in the treated section and 64 vines in the UTC section were evaluated.

Apart of the observations on the re-budded vines, the growth of new re-planted vines was also evaluated.

### Results and Discussion:

Vines pruned to a spur or one cane (weak vines) progressed as usual during the season. Growth was strong at first and then started to slow in late July. In August the vines entered verasion early, the internode distances started to decline and new growth stopped. Red leaves started to appear, all symptoms typical of Armillaria root rot. At this point the treated section showed a surprising resurgence in growth. New green leaves above the stunted looking canopies started to appear. In some cases the canopy actually showed signs of vigorous growth. This phenomenon did not occur in the untreated control section.

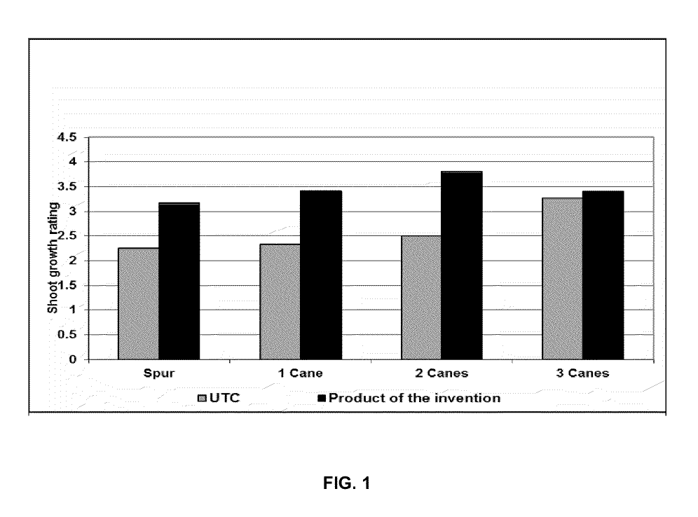

These evaluations are illustrated in FIG. 1.

Newly planted vines responded differently. All the new root stock planted in the treated section and the untreated control sections got a slow start and needed most of July to have growth appearing above the tubes. In August and September the new vines in the treated section showed vigorous growth consistently. By the end of the growing season the new vines in the treated section were 2 to 3 times the volume of canopy as those in the untreated control section.

The method of treatment resulted in improved the soil conditions and directly impacted on the fungus itself. This improvement assisted in new root and shoot growth.

All publications, patents and patent applications cited in this specification are incorporated herein by reference in their entireties as if each individual publication, patent or patent application were specifically and individually indicated to be incorporated by reference. While the foregoing has been described in terms of various embodiments, the skilled artisan will appreciate that various modifications, substitutions, omissions, and changes may be made without departing from the spirit thereof.

1) A method for treating root rot infected plants, wherein the method comprises applying to the base of the plant and the soil surrounding the plant an effective amount of a composition comprising one or more surfactants, one or more alcohols, and one or more high terpene containing oils.

2) The method of claim 1, wherein the method comprises increasing lateral movement of water in the soil where the plant grows and thereby improving drainage of the soil.

3) A method of claim 1, wherein the method comprises diluting the composition with water and applying the diluted composition to the base of the plant and the soil around the plant.

4) The method of claim 3, wherein the composition is applied by spraying, drenching dribbling, watering, or any other method of application.

5) The method of claim 1, wherein the composition comprises one or more high terpene containing oils selected from the group consisting of orange oil, lemon oil, lime oil, grapefruit oil, pine oil and tangerine oil.

6) The method of claim 5, wherein the high terpene containing oil is cold pressed orange oil.

7) The method of claim 1, wherein the composition is a concentrate.

8) The method of claim 7, wherein the concentrate comprises between about 1% and about 35% by weight of orange oil, relative to the total weight of the composition.

9) The method of claim 8, wherein the concentrate comprises between about 2% to about 15% by weight of orange oil.

10) The method of claim 9, wherein the concentrate comprises between about 5% to about 12% by weight of orange oil.

11) The method of claim 10, wherein the concentrate comprises about 10% by weight of orange oil.

12) The method of claim 8, wherein the one or more alcohol is ethyl alcohol.

13) The method of claim 12, wherein the concentrate comprises between about 1% to about 15% by weight of ethyl alcohol, relative to the total weight of the composition.

14) The method of claim 8, wherein the one or more alcohol is propylene glycol.

15) The method of claim 14, wherein the concentrate comprises between about 5% to about 20% by weight propylene glycol, relative to the total weight of the composition.

16) The method of claim 8, wherein the one or more alcohol is a secondary alcohol ethoxylate.

17) The method of claim 16, wherein the concentrate comprises between about 10% to about 30% by weight secondary alcohol ethoxylate, relative to the total weight of the composition.

18) The method of claim 17, wherein the concentrate comprises about 20% by weight secondary alcohol ethoxylate.

19) The method of claim 1, wherein the composition is applied at a rate of between about 1 litre/hectare to about 100 litres/hectare.

20) The method of claim 3, wherein the concentrate is diluted at a dilution rate of about 0.01% to about 2% is applied at a rate of between about 100 litres/hectare to about 100 000 litres/hectare.

21) The method of claim 3, wherein the composition is applied at a rate of between about 2 litres/hectare to about 50 litres/hectare.

22) The method claim 3, wherein the composition is applied at a rate of between about 5 litres/hectare to about 30 litres/hectare.

23) The method of claim 3, wherein the composition is applied at a rate of between about 8 litres/hectare to about 20 litres/hectare.

24) A method for treating Armillaria infected plants, wherein the method comprises applying to the soil surrounding the plant an effective amount of a composition comprising one or more surfactants, one or more alcohols, and one or more high terpene containing oils.

25) A method of controlling Armillaria disease, wherein the method comprises selecting soil where an infected plant is growing, applying to the soil an effective amount of a composition comprising one or more surfactants, one or more alcohols, and one or more high terpene containing oils.
